(19) United States
(12) Patent Application Publication
(10) Pub. No.: US 2024/0305734 A1
(43) Pub. Date: Sep. 12, 2024

(54) INFORMATION PROCESSING SYSTEM

(71) Applicant: FUJIFILM Business Innovation Corp., Tokyo (JP)

(72) Inventor: Yusuke KAMOI, Kanagawa (JP)

(73) Assignee: FUJIFILM Business Innovation Corp., Tokyo (JP)

(21) Appl. No.: 18/447,447

(22) Filed: Aug. 10, 2023

(30) Foreign Application Priority Data
Mar. 9, 2023 (JP) 2023-036597

(51) Int. Cl. H04N 1/34; G06Q 30/0283; H04N 1/00

(52) U.S. Cl. CPC H04N 1/344; G06Q 30/0283; H04N 1/00413; H04N 1/0084

(57) ABSTRACT

An information processing system includes a processor configured to: calculate a charge for an exchange of a final product of a service; and when a first user who orders execution of the service is different from a second user who receives the final product of the service, upon approval of both the first user and the second user, change a user to be charged of the charge for the exchange of the final product of the service from the first user to the second user.

### CROSS-REFERENCE TO RELATED APPLICATIONS

This application is based on and claims priority under 35 USC 119 from Japanese Patent Application No. 2023-036597 filed Mar. 9, 2023.

### BACKGROUND

### (i) Technical Field

The present disclosure relates to an information processing system.

### (ii) Related Art

Japanese Unexamined Patent Application Publication No. 2003-122533 discloses a printing system that, when network printing is performed, allows charges for use charged by a billing manager to be allocated among providers and paid according to the number of sheets printed.

Japanese Unexamined Patent Application Publication No. 2003-256522 discloses a group payment system that allows a customer to place an order while checking the order of himself or herself and has a bill-splitting function for group utilization.

Japanese Unexamined Patent Application Publication No. 2019-16013 discloses a data output service system that allows a user different from a receiver of an output to make payment for the charge in a service of data output such as print and copy.

### SUMMARY

Some unmanned payment stores adopt a system that eliminates the need for cash register transaction, and allows a customer to make payment by just picking up products and leaving the store. A system may be adopted which, upon pick-up of a commodity or use of a service, calculates the charge for an exchange of the commodity or the service, and allows a customer to collectively make payment for charges when leaving the store.

However, for use of a service in an unmanned payment store, a user who has ordered execution of the service may be different from a user who has received a final product of the service, and a user to be charged may be desired to be different from the user who has ordered execution of the service.

Aspects of non-limiting embodiments of the present disclosure relate to an information processing system that, when a user who has ordered execution of a service is different from a user who has received a final product of the service, can designate, as the user to be charged, a user other than the user who has ordered execution of the service.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: calculate a charge for an exchange of a final product of a service; and when a first user who orders execution of the service is different from a second user who receives the final product of the service, upon approval of both the first user and the second user, change a user to be charged of the charge for the exchange of the final product of the service from the first user to the second user.

### BRIEF DESCRIPTION OF THE DRAWINGS

Exemplary embodiments of the present disclosure will be described in detail based on the following figures, wherein:

FIG. 1 is a diagram illustrating the system configuration of an information processing system according to an exemplary embodiment of the present disclosure;

FIG. 2 is a block diagram illustrating the hardware configuration of a system server 20 in the exemplary embodiment of the present disclosure;

FIG. 3 is a block diagram illustrating the functional configuration of the system server 20 in the exemplary embodiment of the present disclosure;

FIG. 4 is a table illustrating an example of a surveillance target list stored in a data storage 33;

FIG. 5 is a block diagram illustrating the hardware configuration of an image forming apparatus 10 in the exemplary embodiment of the present disclosure;

FIG. 6 is a block diagram illustrating the functional configuration of the image forming apparatus 10 in the exemplary embodiment of the present disclosure;

FIG. 7 is a table illustrating an example of a charge table stored in a data storage 45;

FIG. 8 is a flowchart for illustrating the process of the image forming apparatus 10 in the exemplary embodiment of the present disclosure;

FIG. 9 is a view illustrating an operation screen example of the image forming apparatus 10 in the exemplary embodiment of the present disclosure;

FIG. 10 is a view illustrating an operation screen example of the image forming apparatus 10 in the exemplary embodiment of the present disclosure;

FIG. 11 is a view illustrating a modification of an operation screen example of the image forming apparatus 10 in the exemplary embodiment of the present disclosure;

FIG. 12 is a flowchart for illustrating the process of an image forming apparatus 10 in a second exemplary embodiment of the present disclosure;

FIG. 13 is a flowchart for illustrating the process of an image forming apparatus 10 in a third exemplary embodiment of the present disclosure;

FIG. 14 is a view illustrating a modification of the operation screen of the image forming apparatus 10 in the exemplary embodiment of the present disclosure;

FIG. 15 is a view illustrating a modification of the operation screen of the image forming apparatus 10 in the exemplary embodiment of the present disclosure;

FIG. 16 is a view illustrating a modification of the operation screen of the image forming apparatus 10 in the exemplary embodiment of the present disclosure; and

FIG. 17 is a view illustrating a modification of the operation screen of the image forming apparatus 10 in the exemplary embodiment of the present disclosure.

### DETAILED DESCRIPTION

Hereinafter, an exemplary embodiment of the present disclosure will be described in detail with reference to the drawings.

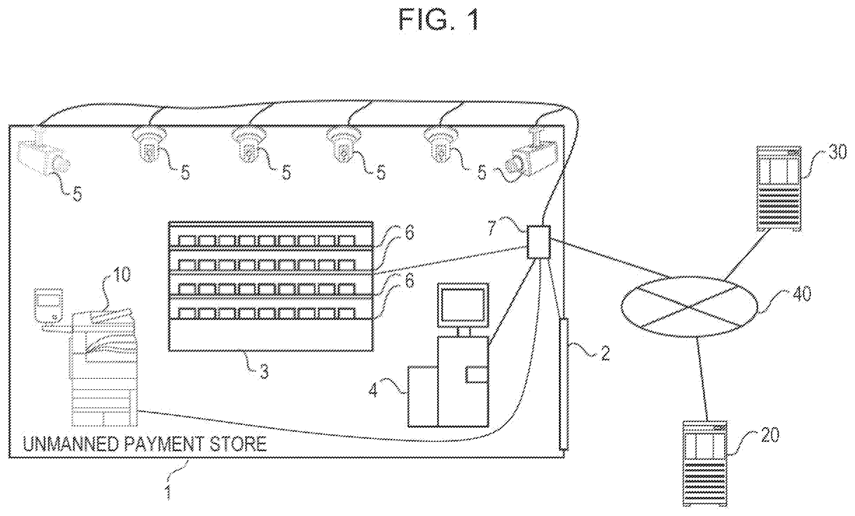

FIG. 1 is a diagram illustrating the configuration of an information processing system according to an exemplary embodiment of the present disclosure.

In an unmanned payment store 1, a gate 2 serving as a door for users who utilize the store, a display cabinet 3 where products are displayed, an image forming apparatus 10, a payment terminal 4 to collectively make payment for commodities and the charges for exchange of final products obtained by use of services, and cameras 5 as imaging devices are installed. The display cabinet 3 is provided with a plurality of sensors 6 as detectors for detecting whether a product is taken. As the sensors 6, for example, weight sensors are used.

In the information processing system according to an exemplary embodiment of the present disclosure, the gate 2, the image forming apparatus 10, the payment terminal 4, the plurality of cameras 5, and the plurality of sensors 6 are each connected to a router 7, and the router 7, a system server 20, and a charging server 30 are connected to each other via an Internet 40.

The system server 20 is a system management apparatus that manages information on the users who visit (also referred to as enter or leave) the unmanned payment store 1, and information on utilization of products and services in the unmanned payment store 1.

The charging server 30 is a charging management apparatus that performs payment processing of collectively calculating the charges for exchange of commodities and the charges for final products obtained by use of services for each user.

The image forming apparatus 10 is an apparatus so-called multifunction printer having multiple functions, such as a print function using paper such as normal paper and photo paper, a scan function, a copy function, and a facsimile function. A user can utilize a print service, such as copy, scan, print of the image forming apparatus 10. The image forming apparatus 10 is an example of a service providing apparatus that provides a service in the unmanned payment store 1.

Specifically, the system server 20 uses the image information from the plurality of cameras 5 to monitor the users who have entered the unmanned payment store 1 through the gate 2 until the users leave the store 1. The system server 20 then obtains information on the commodities picked up by the users and on use of services by the users by the plurality of cameras 5, and the plurality of sensors 6. Specifically, the system server 20 recognizes any commodity picked up by a user, and use of a service in real-time by the image information obtained from the plurality of cameras 5, and by the plurality of sensors 6 installed in the display cabinet 3. The system server 20 then transmits, to the charging server 30, information on the commodity picked up and use of a service.

When obtaining the information on the commodity picked up and use of a service from the system server 20, the charging server 30 performs payment processing of collectively calculating the charges for exchange of the commodity and for a final product obtained by utilization of the service for each user. The charging server 30 then transmits the amount charged to each user to the system server 20.

For example, when printing is performed by user A with the image forming apparatus 10, information on the print content, such as the number of printed sheets of paper, the type and size of paper, and information on the user A who performed printing are transmitted to the charging server 30 via the system server 20. In the charging server 30, the amount charged according to the number of printed sheets and the print content is calculated, and the system server 20 is notified of the information on the user A who performed printing and the calculated amount charged.

When a user who has picked up a commodity or utilized a service enters a payment area, which is the periphery of the payment terminal 4, the details of the picked up commodity and the utilized service, and the amount charged are displayed on the display of the payment terminal 4. Thus, a user in the payment area can check the displayed details and make payment.

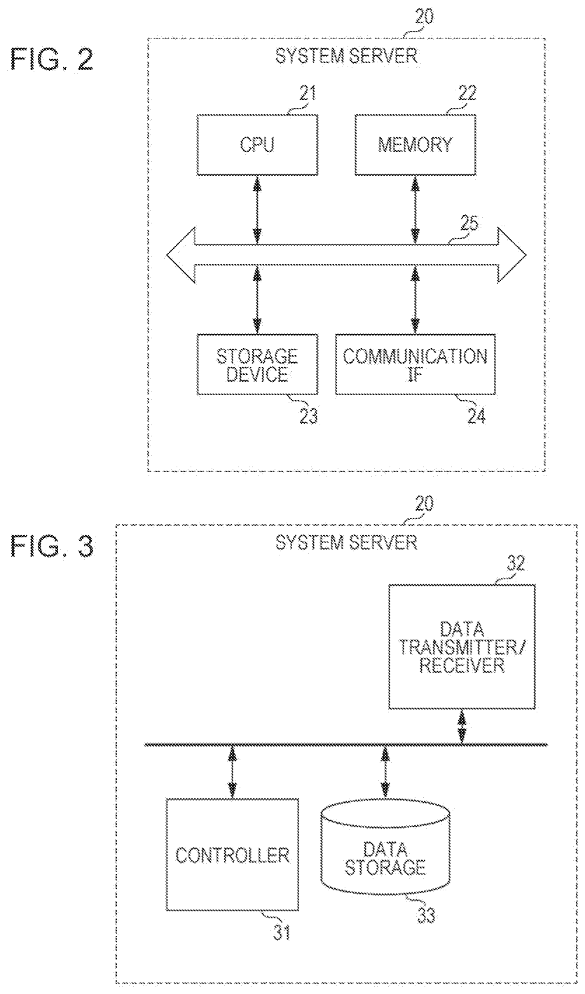

First, the hardware configuration of the system server 20 in the exemplary embodiment is illustrated in FIG. 2.

As illustrated in FIG. 2, the system server 20 has a CPU 21, a memory 22, a storage device 23 such as a hard disk drive (HDD), and a communication interface (IF) 24. These components are connected to each other via a control bus 25. The communication IF 24 is configured to transmit and receive data via the Internet 40 to and from the charging server 30, and the image forming apparatus 10, the payment terminal 4, the cameras 5, and the sensors 6 which are installed in the unmanned payment store 1.

The CPU 21 is a processor that executes a predetermined process based on a control program stored in the memory 22 or the storage device 23, and controls the operation of the system server 20. Note that in the exemplary embodiment, the CPU 21 has been described as a processor that reads and executes a control program stored in the memory 22 or the storage device 23, but is not limited thereto. The control program may be provided in a form of a computer readable recording medium on which the control program is recorded. For example, the program may be provided in a form of an optical disk, such as a compact disc (CD)-ROM and a digital versatile disc (DVD)-ROM, on which the program is recorded, or a form of a semiconductor memory, such as a Universal Serial Bus (USB) memory and a memory card, on which the program is recorded. Alternatively, the control program may be obtained from an external device via a communication line connected to the communication IF 24.

FIG. 3 is a block diagram illustrating the functional configuration of the system server 20 which is implemented by the above-mentioned control program being executed.

As illustrated in FIG. 3, the system server 20 in the exemplary embodiment includes a controller 31, a data transmitter/receiver 32, and a data storage 33.

The data transmitter/receiver 32 transmits and receives data via the Internet 40 between the charging server 30, the image forming apparatus 10, the payment terminal 4, the cameras 5, and the sensors 6 which are installed in the unmanned payment store 1.

The controller 31 identifies the user via the Internet 40 using image information which is captured by the cameras 5 installed in the unmanned payment store 1. The controller 31 then obtains information on the store entry time and store exit time of the identified user.

The controller 31 uses the image information captured by the cameras 5 installed in the unmanned payment store 1 via the Internet 40 to obtain the time when a commodity is picked up by a user, the time when a service is utilized with the image forming apparatus 10 (in other words, the time when a commodity or/and a service are provided), and information on the commodity, such as the details and charge for the commodity, and information on utilization of service such as the details of a utilized service and the charge for an exchange of a final product.

The controller 31 obtains information from the sensors 6 installed in the display cabinet 3 to obtain the time when a commodity is picked up by a user, and information on the commodity, such as the details and charge for the commodity.

The controller 31 generates a surveillance target list for monitoring entered users until the users leave the store, and stores the surveillance target list in the data storage 33.

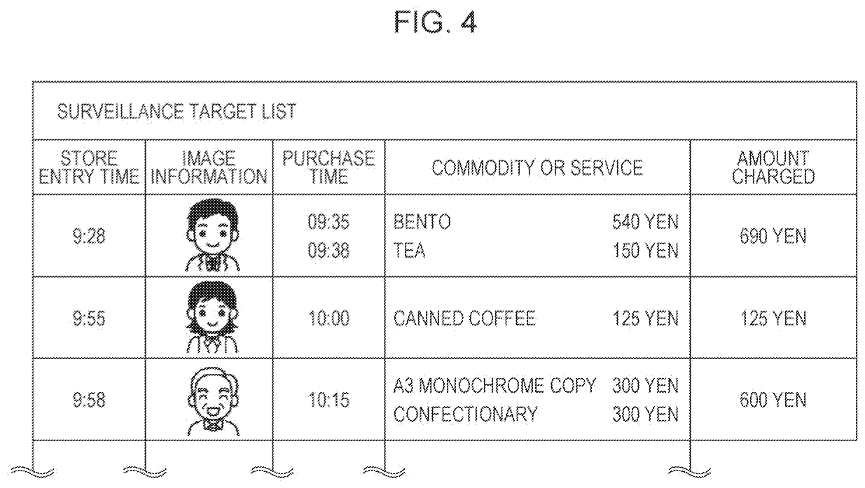

As illustrated in FIG. 4, the store entry time of each user, image information to identify the entered user, the time when a commodity or/and a service are provided, information on utilization of the commodity or/and service, and the amount charged are stored in the data storage 33 in association with each other.

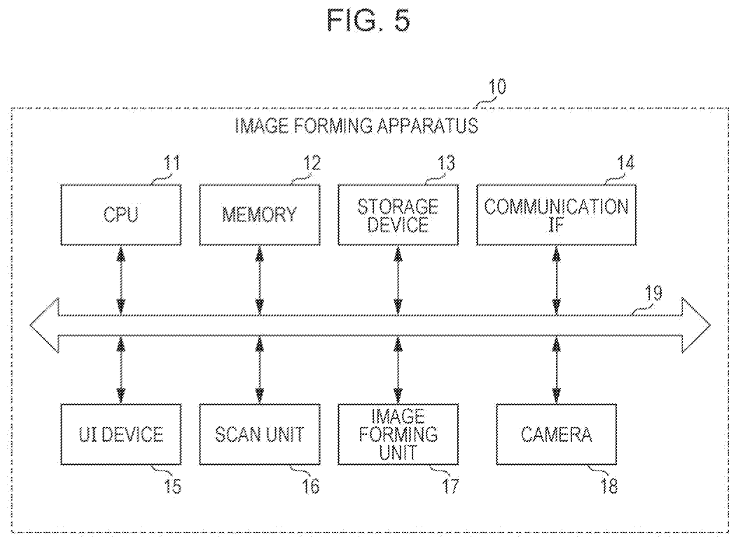

Next, the hardware configuration of the image forming apparatus 10 in the exemplary embodiment is illustrated in FIG. 5.

As illustrated in FIG. 5, the image forming apparatus 10 has a CPU 11, a memory 12, a storage device 13 such as an HDD, a communication IF 14, an UI device 15 such as a touch panel, a scan unit 16, an image forming unit 17, and a camera 18 as an imaging device. These components are connected to each other via a control bus 19. The communication IF 14 transmits and receives data via the Internet 40 between the system server 20, the charging server 30, and another external device.

The CPU 11 is a processor that executes a predetermined process based on a control program stored in the memory 12 or the storage device 13, and controls the operation of the image forming apparatus 10. Note that in the exemplary embodiment, the CPU 11 has been described as a processor that reads and executes a control program stored in the memory 12 or the storage device 13, but is not limited thereto. The control program may be provided in a form of a computer readable recording medium on which the control program is recorded. For example, the program may be provided in a form of an optical disk, such as a CD-ROM and a DVD-ROM, on which the program is recorded, or a form of a semiconductor memory, such as a USB memory and a memory card, on which the program is recorded. Alternatively, the control program may be obtained from an external device via a communication line connected to the communication IF 14.

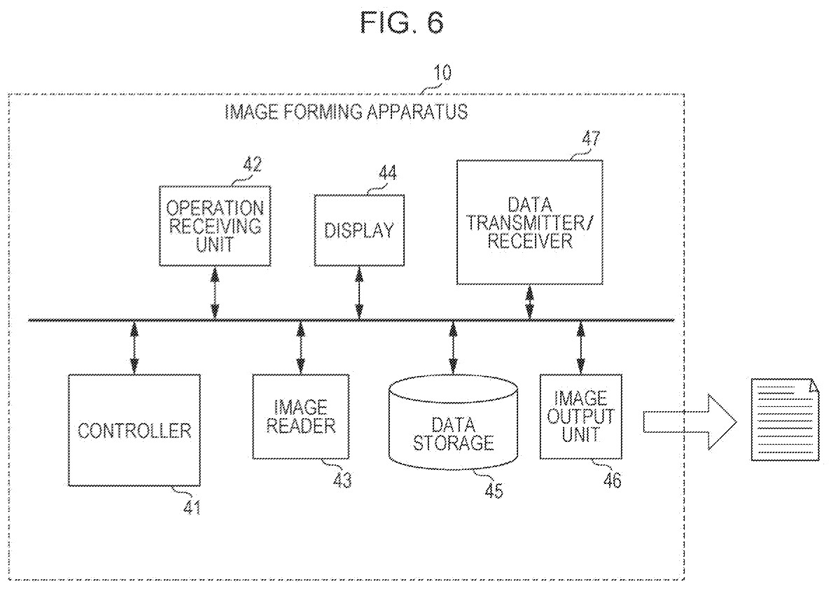

FIG. 6 is a block diagram illustrating the functional configuration of the image forming apparatus 10 which is implemented by the above-mentioned control program being executed.

As illustrated in FIG. 6, the image forming apparatus 10 in the exemplary embodiment includes a controller 41, an operation receiving unit 42, an image reader 43, a display 44, a data storage 45, an image output unit 46, and a data transmitter/receiver 47.

The data transmitter/receiver 47 transmits and receives data to and from external devices, such as the system server 20, and the charging server 30.

The display 44 is controlled by the controller 41, and displays various information for a user. The operation receiving unit 42 receives various operations from a user to the image forming apparatus 10. Note that in the exemplary embodiment, the touch panel that is an operation screen is constituted by the display 44 and the operation receiving unit 42 described above.

The controller 41 controls the image reader 43 and the image output unit 46 to execute various print services such as print, copy, and scan. The data storage 45 stores various data such as print data generated by the controller 41.

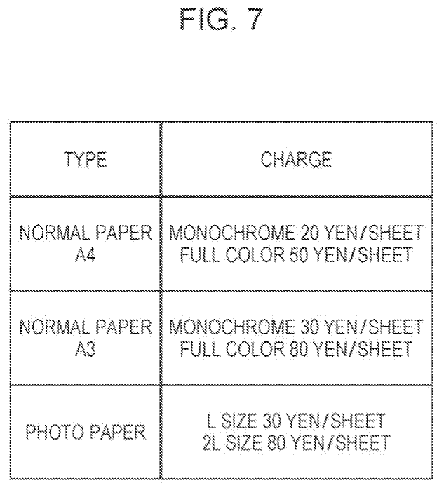

As illustrated in FIG. 7, the data storage 45 stores a charge table that defines the type of paper, and the unit charge for each of various print services when the image forming apparatus 10 is utilized.

The image output unit 46 outputs an image on a printing material such as print paper based on the control by the controller 41. The image reader 43 reads an original image from a set document based on the control by the controller 41.

When execution of a print service such as copy, or print is ordered by a user, the controller 41 transmits information on utilization of the print service to the system server 20.

In addition, the controller 41 obtains, from the system server 20 via the data transmitter/receiver 47, information on a user (also referred to as a first user or operator) who has ordered execution of printing. In addition, the controller 41 obtains, from the system server 20 via the data transmitter/receiver 47, information on a user (also referred to as a second user or taker) who has received a printed material.

In addition, the controller 41 transmits, to the charging server 30 via the system server 20, information on the user utilizing the service, and information on the charge for an exchange of a final product of the service.

In addition, when the printed material includes multiple sheets of paper, the controller 41 sets the number of sheets to be charged to another user among the multiple sheets, and performs control to change the user to be charged of the charge for the set number of sheets to another user.

When the user A orders execution of printing upon utilization of the image forming apparatus 10 in the unmanned payment store 1, the user to be charged of the charge of printing is the user A. However, even when the user A orders execution of printing, user B different from the user A may desire to receive a printed material and pay for it. According to the exemplary embodiment, when the user who has ordered execution of printing is different from the user who receives a printed material, the user to be charged can be changed to a user other than the user who has ordered execution of printing.

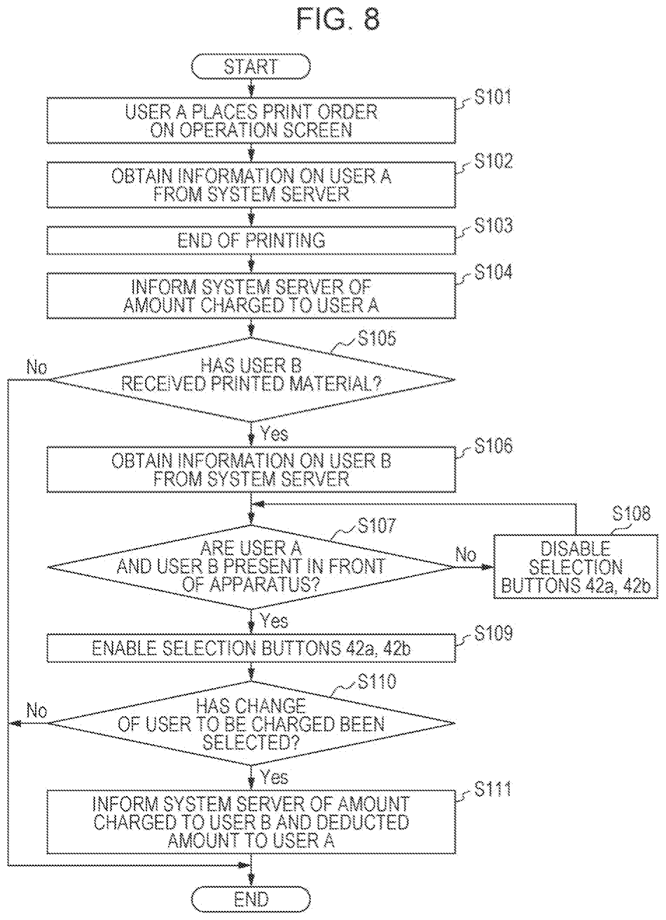

When the user who has ordered execution of printing is different from the user who receives a printed material as described above, the operation of the image forming apparatus 10 will be described with reference to the flowchart in FIG. 8.

First, in step S101, the controller 41 receives an operation of the user A by the operation receiving unit 42, thus orders execution of printing with the number of copies, paper size, monochrome/color print specified. The controller 41 controls the image reader 43 to execute pre-scan of reading the set original image. The controller 41 then executes the print process ordered by the user A.

Then, in step S102, the controller 41 obtains information on the user A who has ordered execution of printing from the system server 20, and is an operator of the image forming apparatus 10. The controller 41 receives and obtains, from the system server 20, information on the user A identified based on the image information captured by the cameras 5.

When printing ends in step S103, the controller 41 informs the charging server 30 of the amount charged to the user A via the system server 20 in step S104, the amount charged being information on utilization of the print service by the user A.

Then, the charging server 30 calculates the charge for an exchange of a printed material obtained through the print service executed by the user A based on the information on utilization of the print service by the user A. For example, when the unit charge for monochrome copy of A3 paper is 30 yen per sheet, and monochrome copy of 10 sheets of A3 paper is to be executed, the amount charged to the user A is calculated as 30 yen×10 sheets=300 yen in the charging server 30. When payment processing is performed by the charging server 30, the system server 20 is informed of the amount charged to the user A.

In step S105, it is determined whether the user B has received a printed material. When it is determined in the system server 20 based on the image information captured by the cameras 5 that the user B different from the user A who executed printing has received a printed material from an output tray, the controller 41 obtains information on the user B from the system server 20 in step S106. When it is determined that the user B different from the user A has not received a printed material from an output tray, the process ends.

In step S107, the controller 41 determines whether the user A and the user B are present in front of the image forming apparatus 10. Then, the controller 41 determines based on the image information captured by the cameras 5 whether the user A and the user B are present in front of the image forming apparatus 10. Specifically, the controller 41 determines whether the user A who has ordered execution of printing and the user B who has received a printed material are present.

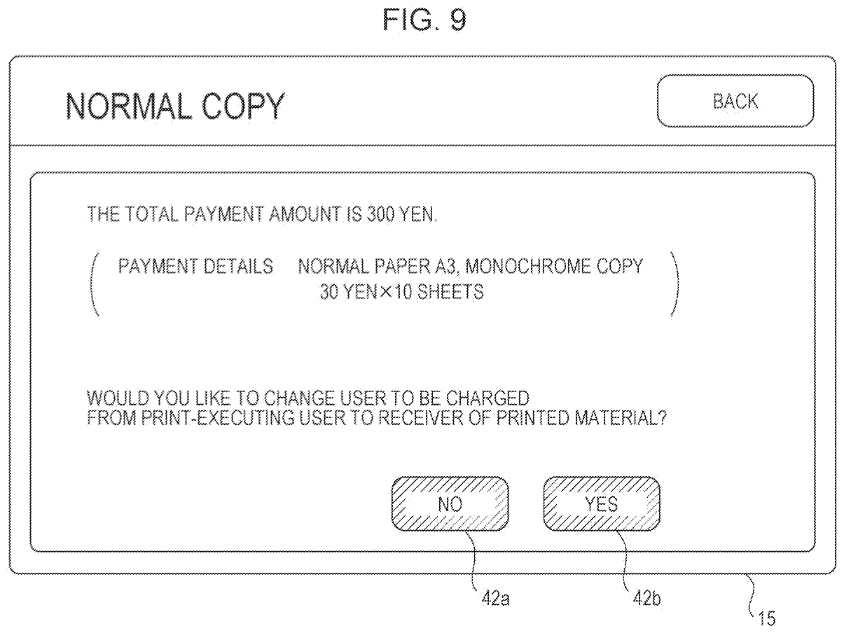

In step S107, when the user A identified in step S102 and the user B identified in step S106 are determined not to be present in front of the image forming apparatus 10 based on the image information captured by the cameras 5, in step S108, as illustrated in FIG. 9, the controller 41 performs control to gray out and disable “NO” button 42a serving as an operation button to keep the user to be charged unchanged as well as “YES” button 42b serving as an operation button to change the user to be charged on the operation screen of the UI device 15, both serving as operation buttons for selecting whether the user to be charged is changed. In other words, the controller 41 disables the operation using the “NO” button 42a and the “YES” button 42b to prevent each button from being selected.

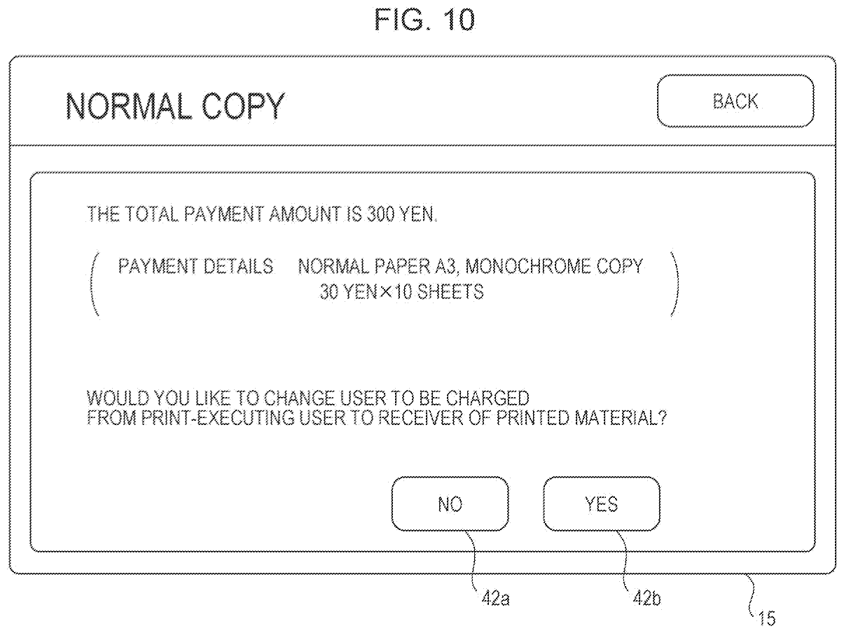

In step S107, when both the user A identified in step S102 and the user B identified in step S106 are determined to be present in front of the image forming apparatus 10 based on the image information captured by the cameras 5, in step S109, as illustrated in FIG. 10, the controller 41 performs control to enable each of the “NO” button 42a and the “YES” button 42b on the operation screen of the UI device 15. In other words, in a selection screen for selecting whether the user to be charged is changed, the controller 41 enables each of the operation button to keep the user to be charged unchanged and the operation button to change the user to be charged so that each button can be selected. In other words, the controller 41 performs control to achieve a state in which it is possible to select whether the user to be charged is changed.

In step S110, the controller 41 determines whether change of the user to be charged is selected. When the “NO” button 42a is depressed, and selection of no change of the user to be charged is received, the process ends. In other words, the user to be charged is remains to be the user A who has ordered execution of printing.

In step S110, when the “YES” button 42b is depressed, and selection of change of the user to be charged is received, in step S111, the controller 41 informs the charging server 30 of the amount charged to the user B, and the amount deducted to the user A via the system server 20.

Specifically, when change of the user to be charged is selected on the operation screen of the image forming apparatus 10 with both the user A who has ordered execution of printing and the user B who has received a printed material present in front of the image forming apparatus 10, the controller 41 assumes that both the user A and the user B have approved the change of the user to be charged, and performs control so that the user to be charged of the charge for an exchange of a printed material can be changed from the user A to the user B.

The charging server 30 then deducts the amount to be additionally charged to the user B from the amount charged to the user A. The charging server 30 adds the amount to be additionally charged to the user B to the amount charged to the user B, and informs the system server 20 of the modified amount charged to the user A, and the modified amount charged to the user B.

For example, in the case where the user A executes printing, the user B receives a printed material, the amount charged to the user A is 600 yen, and the amount charged to the user B is 150 yen before the user to be charged is changed, when selection is made so that the amount charged to the user B is changed so as to include copy charge of 300 yen with the image forming apparatus 10 out of the amount 600 yen charged to the user A, the copy charge 300 yen is subtracted from the amount 600 yen charged to the user A, whereas the copy charge 300 yen is added to the amount 150 yen charged to the user B. In the charging server 30, 300 yen as the modified amount charged to the user A, and 450 yen as the modified amount charged to the user B are calculated, and the system server 20 is notified of those modified amounts.

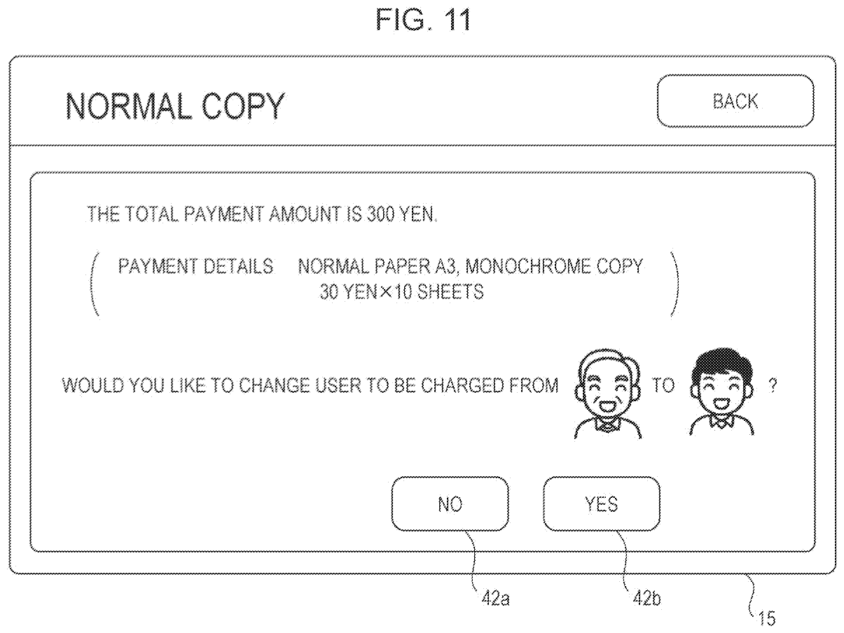

FIG. 11 is a view illustrating a modification of the operation screen of the UI device 15 in step S109 described above.

As illustrated in FIG. 11, in the selection screen for selecting whether the user to be charged is changed, image information of the user A who has ordered execution of printing and the user B who has received a printed material may be displayed to allow an operation to change the user to be charged. Also, in this case, with both the user A who has ordered execution of printing and the user B who has received a printed material present in front of the image forming apparatus 10, the controller 41 enables the “NO” button 42a serving as an operation button to keep the user to be charged unchanged as well as the “YES” button 42b serving as an operation button to change the user to be charged on the operation screen of the UI device 15 so that each button can be operated.

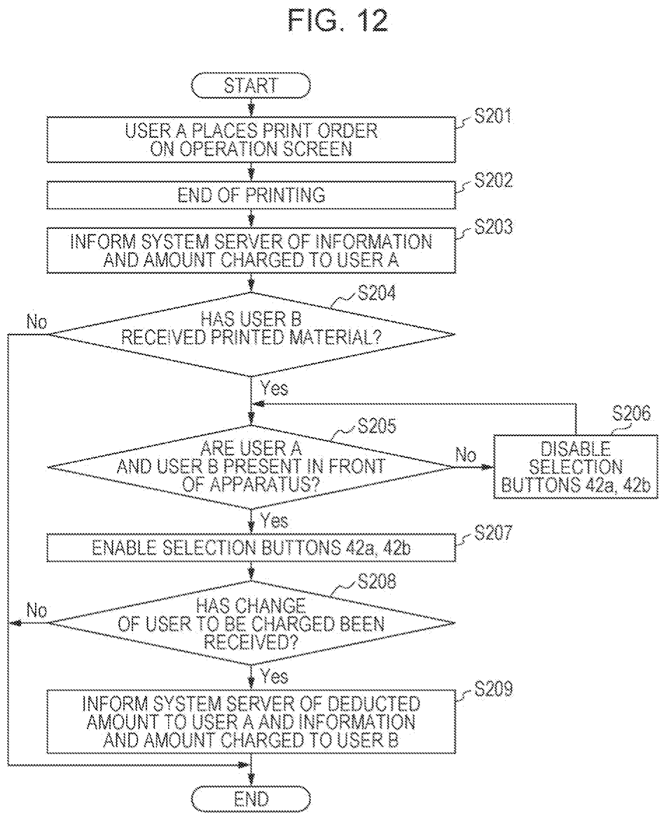

Next, the operation of the image forming apparatus 10 in a second exemplary embodiment of the present disclosure will be described with reference to the flowchart in FIG. 12. In the exemplary embodiment, the cameras 18 provided in the image forming apparatus 10 are used to identify the user A who has ordered execution of printing and the user B who has received a printed material. Note that in the following, a description of a common part with the above-described operation of the image forming apparatus 10 in FIG. 8 is simplified.

First, in step S201, the controller 41 receives an order of the user A at the operation receiving unit 42, and executes a print process.

When printing ends in step S202, the controller 41 informs the charging server 30 of information and an amount charged via the system server 20 in step S203, the information being on the user A who has ordered execution of printing, the amount charged being information on utilization of the print service. Then, the controller 41 informs the system server 20 of information on the user A identified based on the image information captured by the cameras 18.

In step S204, the controller 41 determines whether the user B different from the user A has received a printed material. When it is determined based on the image information captured by the cameras 18 that the user B different from the user A who executed printing has received a printed material from an output tray, the flow proceeds to step S205. When it is determined that the user B different from the user A has not received a printed material from an output tray, the process ends. In step S205, it is determined whether the user A identified in step S203 and the user B identified in step S204 are present in front of the image forming apparatus 10. Then, the controller 41 determines whether the user A and the user B are present based on the image information captured by the cameras 18. Specifically, the controller 41 determines whether the user A who has ordered execution of printing and the user B who has received a printed material are present.

In step S205, when the user A identified in step S203 and the user B identified in step S204 are determined not to be present in front of the image forming apparatus 10 based on the image information captured by the cameras 18, in step S206, as illustrated in FIG. 9, the controller 41 performs control to gray out and disable “NO” button 42a serving as an operation button to keep the user to be charged unchanged as well as “YES” button 42b serving as an operation button to change the user to be charged on the operation screen of the UI device 15, both serving as operation buttons for selecting whether the user to be charged is changed.

In step S205, when both the user A identified in step S203 and the user B identified in step S204 are determined to be present in front of the image forming apparatus 10 based on the image information captured by the cameras 18, in step S207, as illustrated in FIG. 10, the controller 41 performs control to enable the “NO” button 42a serving as an operation button to keep the user to be charged unchanged as well as the “YES” button 42b serving as an operation button to change the user to be charged on the operation screen of the UI device 15.

In step S208, the controller 41 determines whether change of the user to be charged is selected. When the “NO” button 42a is depressed, and selection of no change of the user to be charged is received, the process ends. In other words, the user to be charged is remains to be the user A who has ordered execution of printing.

In step S208, when the “YES” button 42b is depressed, and selection of change of the user to be charged is received, in step S209, the controller 41 informs the charging server 30 of information on the user B, the amount charged to the user B, and the amount deducted to the user A via the system server 20.

The charging server 30 then deducts the amount to be additionally charged to the user B from the amount charged to the user A. The charging server 30 adds the amount to be additionally charged to the user B to the amount charged to the user B, and informs the system server 20 of the modified amount charged to the user A, and the modified amount charged to the user B.

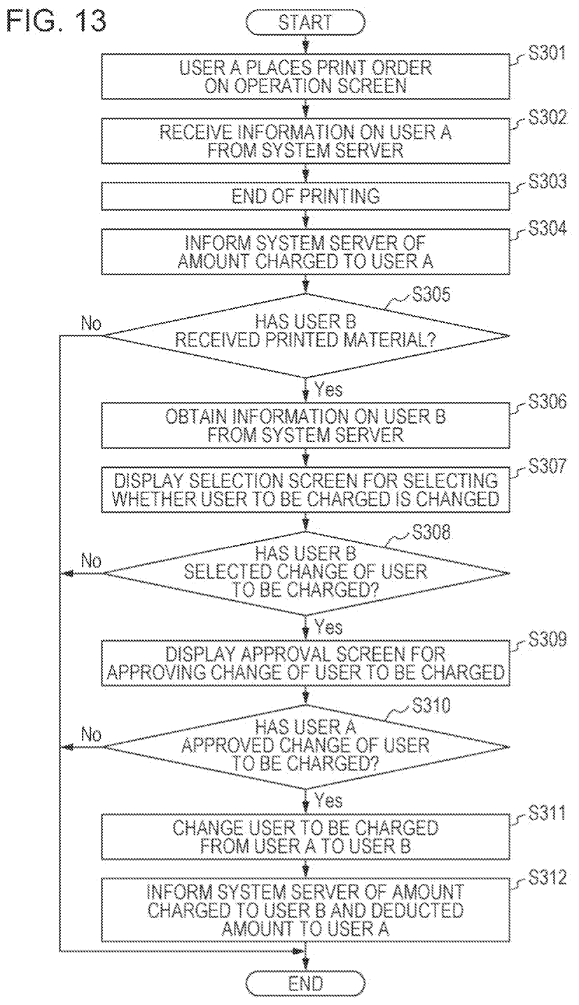

Next, the operation of the image forming apparatus 10 in a third exemplary embodiment of the present disclosure will be described with reference to the flowchart in FIG. 13.

First, in step S301, the controller 41 receives an order of the user A at the operation receiving unit 42, and executes a print process.

Then, in step S302, the controller 41 obtains, from the system server 20, information on the user A who has ordered execution of printing. The controller 41 receives and obtains, from the system server 20, information on the user A identified based on the image information captured by the cameras 5.

When printing ends in step S303, the controller 41 informs the charging server 30 of the amount charged to the user A via the system server 20 in step S304, the amount charged being information on utilization of the print service by the user A.

The charging server 30 calculates the charge for an exchange of a printed material obtained through the print service executed by the user A based on the information on utilization of the service by the user A. When payment processing is performed by the charging server 30, the system server 20 is informed of the amount charged to the user A.

In step S305, the controller 41 determines whether the user B different from the user A has received a printed material. In the system server 20, when it is determined based on the image information captured by the cameras 5 that the user B different from the user A who executed printing has received a printed material from an output tray, the flow proceeds to step S306. When it is determined that the user B different from the user A has not received a printed material from an output tray, the process ends. In step S306, the controller 41 obtains information on the user B from the system server 20.

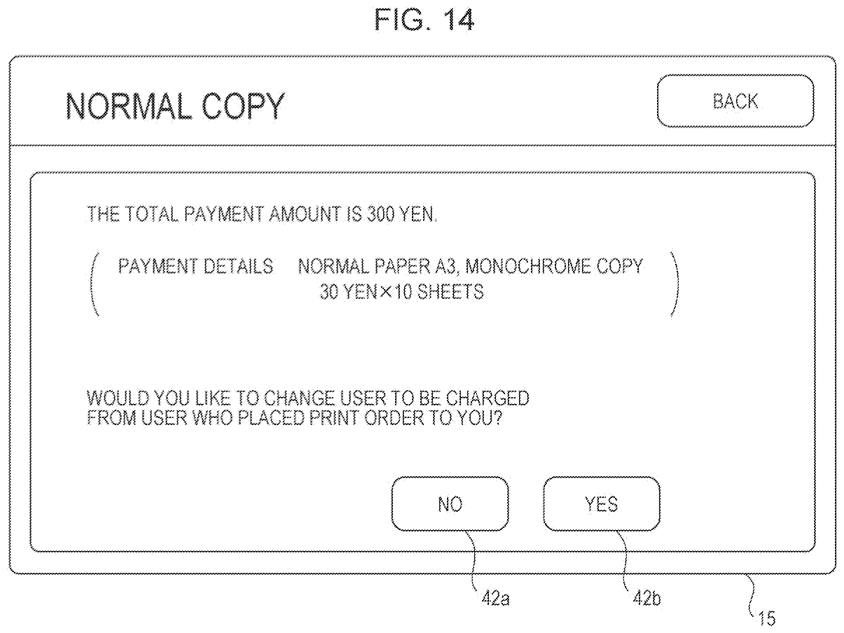

In step S307, as illustrated in FIG. 14, the controller 41 displays, on the operation screen of the UI device 15, a selection screen for selecting whether the user to be charged is changed. When the user B identified based on the image information captured by the cameras 5 is present in front of the image forming apparatus 10, the controller 41 performs control to enable the “NO” button 42a serving as an operation button to keep the user to be charged unchanged as well as the “YES” button 42b serving as an operation button to change the user to be charged.

In step S308, the controller 41 determines based on the image information captured by the cameras 5 whether change of the user to be charged has been selected by the user B who has received a printed material, on the selection screen for selecting whether the user to be charged is changed.

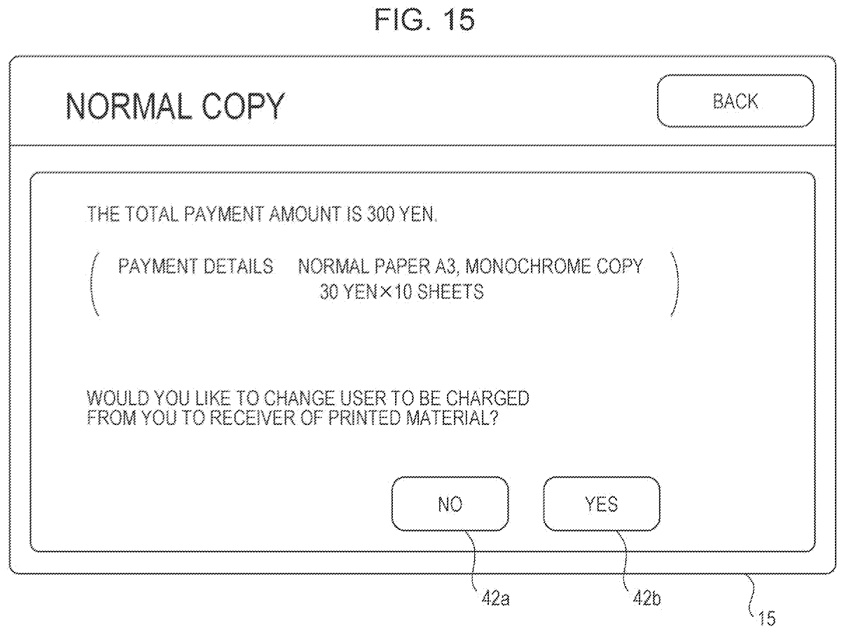

In step S308, when it is determined that the user B has not selected change of the user to be charged, the controller 41 ends the process. When the “YES” button 42b is selected by the user B on the operation screen of the UI device 15 illustrated in FIG. 14, and change of the user to be charged is selected, in step S309, as illustrated in FIG. 15, an approval screen is displayed for inquiring whether the user A who has ordered execution of printing approves change of the user to be charged. When the user A identified based on the image information captured by the cameras 5 is present in front of the image forming apparatus 10, the controller 41 performs control to enable the “NO” button 42a serving as an operation button to keep the user to be charged unchanged as well as the “YES” button 42b serving as an operation button to change the user to be charged.

In step S310, the controller 41 determines whether the user A has approved the change of the user to be charged. When it is determined that the user A has not approved the change of the user to be charged, the process ends. When it is determined based on the image information captured by the cameras 5 that the “YES” button 42b is selected by the user A on the operation screen of the UI device 15 illustrated in FIG. 15, and the user A who has ordered execution of printing has approved the change of the user to be charged, the user to be charged is changed from the user A to the user B in step S311.

In step S312, the controller 41 informs the charging server 30 of the amount charged to the user B, and the amount deducted to the user A via the system server 20.

Note that in steps S308 to S311 described above, when the user A who has ordered execution of printing selects the change of the user to be charged, the controller 41 may perform control so that the user B who has received a printed material is allowed to approve the change of the user to be charged, and upon approval of both the user A and the user B, the user to be charged is changed.

In other words, when change of the user to be charged is selected by one of the user A and the user B, the controller 41 may perform control so that an operation button for approving change of the user to be charged is enabled for the other user, and upon approval of both the user A and the user B, the user to be charged is changed.

The charging server 30 then deducts the amount to be additionally charged to the user B from the amount charged to the user A. The charging server 30 adds the amount to be additionally charged to the user B to the amount charged to the user B, and informs the system server 20 of the modified amount charged to the user A, and the modified amount charged to the user B.

In the above exemplary embodiment, a case has been described in which the total amount of charge for a printed material as a final product is additionally charged to another user, but the present disclosure is not limited to this. Specifically, part of the final product may be additionally charged to another user.

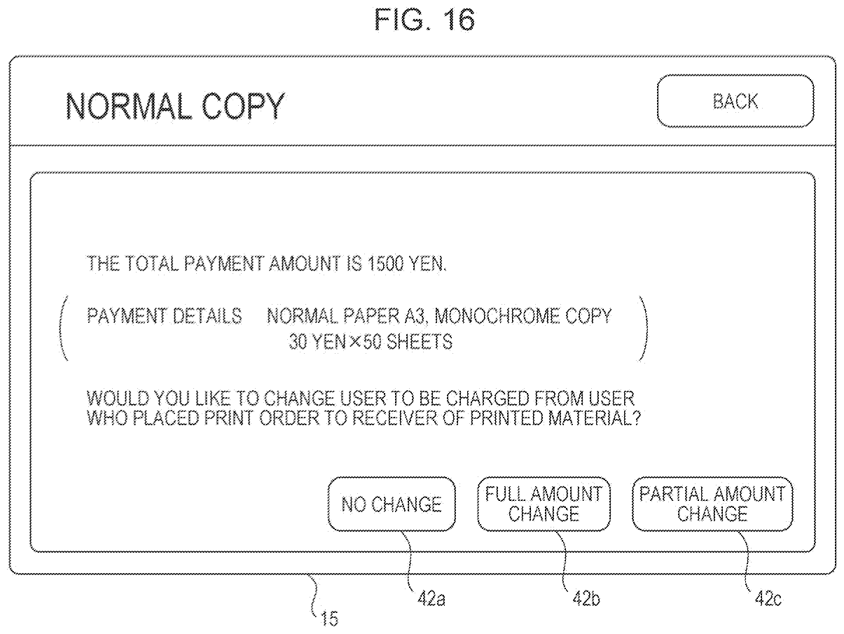

Specifically, for example, as illustrated in FIG. 16, the controller 41 performs control to enable “NO CHANGE” button 42a serving as an operation button to keep the user to be charged unchanged, “FULL AMOUNT CHANGE” button 42b serving as an operation button to change the full amount for the user to be charged, and “PARTIAL AMOUNT CHANGE” button 42c serving as an operation button to change a partial amount for the user to be charged so that one of the operation buttons can be selected on the selection screen for selecting whether the user to be charged is changed.

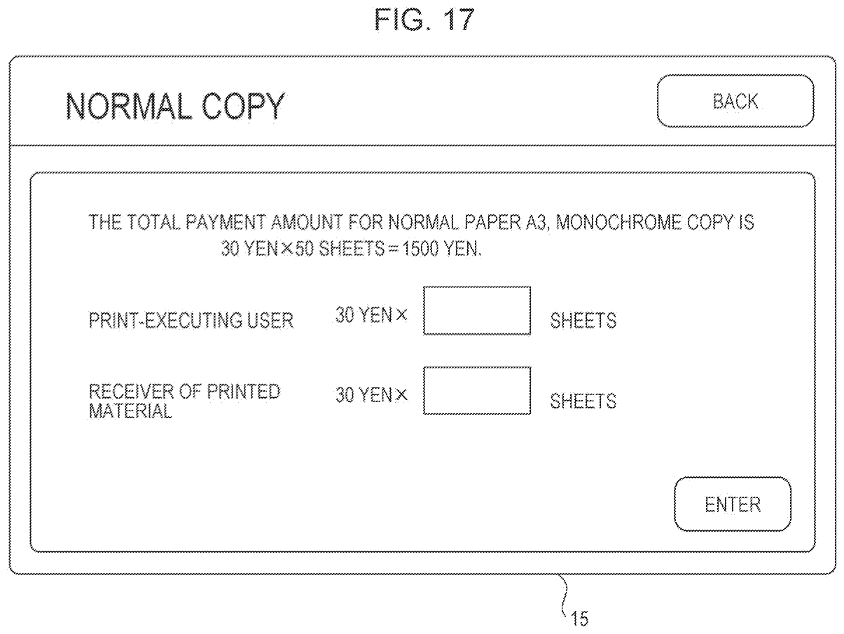

When the printed material includes multiple sheets of paper, and the “PARTIAL AMOUNT CHANGE” button 42c is depressed, for example, as illustrated in FIG. 17, of the multiple sheets of paper, the number of sheets to be charged to each of the user A and the user B is set, and the user to be charged of the charge for the set number of sheets may be changed from the user A to the user B.

According to the exemplary embodiment, for a printed material including multiple sheets of paper, the number of sheets to be charged to each of multiple users can be set. A user to be charged of the charge for the set number of sheets can be designated to a corresponding one of the multiple users and changed.

In the above exemplary embodiment, a case has been described in which a plurality of cameras 5 are used to identify the users who enter the unmanned payment store 1, but the present disclosure is not limited to this, and both the cameras 5 and the cameras 18 may be used. Alternatively, the users who enter the unmanned payment store 1 may be identified using an authentication unit that authenticates those users. For example, the gate 2 may be provided with an authentication unit, and the image information captured by the cameras 5 upon authentication of a user may be used to identify the user by associating the image information of the user with information on the user.

In the above exemplary embodiment, a case has been described in which the selection screen for selecting whether the user to be charged is changed is displayed on the UI device 15 of the image forming apparatus 10, but the present disclosure is not limited to this, and the selection screen may be displayed on the payment terminal 4 or the mobile terminal of each user.

In the above exemplary embodiment, a case has been described in which the charging server 30 is provided separately from the system server 20, but the present disclosure is not limited to this, and the system server 20 may be provided with a payment processor that performs payment processing.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Modifications

In the above exemplary embodiment, a case has been described in which payment is made for the charge for a service provided by the image forming apparatus, but the present disclosure is not limited to this, and the present disclosure is similarly applicable to various information processing apparatuses by which payment of the charge for an exchange of a commodity or a service is made, the commodity or the service being provided by a drink providing apparatus that sells drinks such as coffee and tea, a ticketing machine that sells tickets or admission tickets, and an automatic vending machine that sells various products such as canned juice.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

Hereinafter, an exemplary embodiment of the present disclosure is appended.

(((1)))

An information processing system comprising a processor configured to:
calculate a charge for an exchange of a final product of a service; and
when a first user who orders execution of the service is different from a second user who receives the final product of the service, upon approval of both the first user and the second user, change a user to be charged of the charge for the exchange of the final product of the service from the first user to the second user.
   (((2)))

The information processing system according to (((1))),
wherein the processor is configured to in presence of both the first user and the second user in front of a service providing apparatus that provides the service, enable an operation button to change the user to be charged on an operation screen of the service providing apparatus.
   (((3)))

The information processing system according to (((1))),
wherein the processor is configured to upon selection of change of the user to be charged, by one of the first user or the second user and on an operation screen of a service providing apparatus that provides the service, enable, for the other user, an operation button to approve the change of the user to be charged.
   (((4)))

The information processing system according to any one of (((1))) to (((3))),
wherein the service is a print service, and the final product is a printed material.
   (((5)))

The information processing system according to (((4))),
wherein the processor is configured to: when the printed material includes a plurality of sheets, set a number of sheets to be charged to the second user among the plurality of sheets in the printed material; and
change a user to be charged of a charge for the set number of sheets from the first user to the second user.
   (((6)))

The information processing system according to any one of (((1))) to (((5))), further comprising
an image capturing device that captures images of the first user and the second user,
wherein the processor is configured to identify the first user and the second user based on an image captured by the image capturing device.
   (((7)))

The information processing system according to (((6))),
wherein a plurality of image capturing devices, each of which is the image capturing device, are provided in a store where a service providing apparatus that provides the service is installed.
   (((8)))

The information processing system according to (((6))) or (((7))),
wherein the image capturing device is provided in a service providing apparatus that provides the service.
   (((9)))

The information processing system according to any one of (((6))) to (((8))), further comprising
an authentication unit that authenticates the first user and the second user,
wherein the processor is configured to identify the first user and the second user based on an image captured by the image capturing device upon authentication by the authentication unit.

What is claimed is:

1. An information processing system comprising:
a processor configured to:
calculate a charge for an exchange of a final product of a service; and
when a first user who orders execution of the service is different from a second user who receives the final product of the service, upon approval of both the first user and the second user, change a user to be charged of the charge for the exchange of the final product of the service from the first user to the second user.

2. The information processing system according to claim 1,
wherein the processor is configured to:
in presence of both the first user and the second user in front of a service providing apparatus that provides the service, enable an operation button to change the user to be charged on an operation screen of the service providing apparatus.

3. The information processing system according to claim 1,
wherein the processor is configured to:
upon selection of change of the user to be charged, by one of the first user or the second user and on an operation screen of a service providing apparatus that provides the service, enable, for the other user, an operation button to approve the change of the user to be charged.

4. The information processing system according to claim 1,
wherein the service is a print service, and the final product is a printed material.

5. The information processing system according to claim 4,
wherein the processor is configured to:
when the printed material includes a plurality of sheets, set a number of sheets to be charged to the second user among the plurality of sheets in the printed material; and
change a user to be charged of a charge for the set number of sheets from the first user to the second user.

6. The information processing system according to claim 1, further comprising:
an image capturing device that captures images of the first user and the second user,
wherein the processor is configured to identify the first user and the second user based on an image captured by the image capturing device.

7. The information processing system according to claim 6,
wherein a plurality of image capturing devices, each of which is the image capturing device, are provided in a store where a service providing apparatus that provides the service is installed.

8. The information processing system according to claim 6,
wherein the image capturing device is provided in a service providing apparatus that provides the service.

9. The information processing system according to claim 6, further comprising
an authentication unit that authenticates the first user and the second user,
wherein the processor is configured to identify the first user and the second user based on an image captured by the image capturing device upon authentication by the authentication unit.

10. An information processing system comprising:
means for calculating a charge for an exchange of a final product of a service; and
means for changing, when a first user who orders execution of the service is different from a second user who receives the final product of the service, upon approval of both the first user and the second user, a user to be charged of the charge for the exchange of the final product of the service from the first user to the second user.
